(19) United States
(12) Patent Application Publication
(10) Pub. No.: US 2014/0279667 A1
(43) Pub. Date: Sep. 18, 2014

(54) GROUP DELIVERY SYSTEMS AND RELATED METHODS

(71) Applicant: United Parcel Service of America, Inc., Atlanta, GA (US)

(72) Inventor: Bob Gillen, Alpharetta, GA (US)

(21) Appl. No.: 14/215,756

(22) Filed: Mar. 17, 2014

Related U.S. Application Data
(60) Provisional application No. 61/793,307, filed on Mar. 15, 2013.

(51) Int. Cl. G06Q 10/08

(52) U.S. Cl. CPC G06Q 10/0836
USPC 705/339

(57) ABSTRACT

Various embodiments of a system for creating delivery groups are disclosed. In various embodiments, the system is configured to collect purchase history data about users and determine if they have common characteristics. For example, the system may be configured to determine if two users live in the same neighborhood, have similar purchasing habits, etc. According to a particular embodiment, the system suggests to users with common characteristics to form delivery groups for package aggregation (e.g., to aggregate deliveries to a single location at the same time). The system may offer an incentive to the users to form the delivery group, such as a discount, incentive points, etc.

### CLAIM OF PRIORITY

This application claims the benefit of priority of U.S. Provisional Patent Application No. 61/793,307, filed Mar. 15, 2013, entitled, “Group Delivery Systems and Related Methods,” which is incorporated herein by reference in its entirety.

### BACKGROUND

The increase in online retail purchases has led to a significant increase in parcel deliveries to individual homes. While online purchases can be especially convenient for the consumer, the relatively high delivery costs associated with delivering purchased items directly to each customer's home can be significant. A disproportionate percentage of such costs may include “last mile” delivery costs, which are the costs associated with delivering goods to their final destination. Such costs may be increased when the logistics provider must deliver each individual parcel to a different location, which is common when delivering parcels that include items ordered from online retailers. Various embodiments of the present systems and methods seek to reduce such last mile costs.

### SUMMARY

In various embodiments, a computer system for forming delivery groups includes at least one processor and is configured for: 1) collecting data associated with a plurality of entities, wherein the collected data includes historical data associated with one or more purchases made by the plurality of entities; 2) at least partially based on the collected data, identifying at least one particular user of the plurality of users; 3) suggesting, to the at least one particular entity of the plurality of entities, forming a delivery group; 4) receiving a request to form the delivery group; 5) facilitating formation of the delivery group, wherein: i) the delivery group includes one or more members; and ii) the one or more members of the delivery group include at least one entity of the plurality of entities; 6) enabling at least one delivery group member to designate a delivery location, wherein the delivery location includes a location where all delivery group members can have parcels delivered; and 7) facilitating delivery of a parcel to the designated delivery location.

### BRIEF DESCRIPTION OF THE DRAWINGS

Reference will now be made to the accompanying drawings, which are not necessarily drawn to scale, and wherein:

FIG. 1 shows a block diagram of a Group Delivery System according to one embodiment;

FIG. 2 shows a block diagram of the exemplary Logistics Server of FIG. 1;

FIG. 3 shows a flow diagram that generally illustrates various steps executed by the exemplary Group Identification, Formation, and Delivery Module in FIG. 2 in accordance with various embodiments of the system of FIG. 1; and

FIGS. 4A and 4B are exemplary group delivery package aggregation diagrams.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, is configured to facilitate the creation of delivery groups. In particular embodiments, the computer system: 1) collects purchase history data associated with various users; 2) determines which (if any) users of the various users have common characteristics, such as if any users live in the same geographic area; 3) suggests, to the users having common characteristics, forming a delivery group; 4) receives, from the users, a request to form the delivery group; 5) facilitates formation of the delivery group, where the delivery group members include the users having the common characteristics; 6) enables members of the delivery group to select a delivery location for group deliveries; and 7) facilitates delivery of parcels to the delivery location.

In a particular embodiment, the system is adapted to automatically identify entities (e.g., individuals or businesses) that would make a suitable delivery group and coordinate the formation of the group with the individual entities. In doing so, the system may, for example, collect and analyze data regarding the types of parcels that particular entities receive, and the schedules according to which the entities receive the parcels. The system may also collect data from one or more social networks (e.g., a public, private, and/or business social network, etc.), or other sources, to derive more detailed information regarding the entities' respective connections, preferences, and buying habits. The system may then use the collected data to identify subsets of the entities that may each make a suitable delivery group.

The system may use any suitable algorithm to determine whether it would be advantageous for a particular plurality of entities to form a delivery group. For example, the system may use a suitable algorithm to identify groups of individuals who: 1) live close to one another (e.g., the system is configured to measure and/or receive a distance between two individuals' residences, and/or the time to travel from one individual's residence to another individual's residence); 2) regularly receive parcels on the same day of the week; and/or 3) are “friends” with each other on a social network. Such groups of individuals may, for example, be neighbors within a subdivision or classmates at a university.

After identifying a plurality of entities that would make a suitable delivery group, the system suggests to the entities (e.g., via any suitable electronic or non-electronic communication, such as one or more e-mail messages, SMS messages, and/or postings on a page of a social network) that the entities form a delivery group. In doing so, the system may, for example, provide incentives for forming the delivery group. For example, the system may offer an incentive program (e.g., bonus points, coupons, etc.) associated with one or more retail websites provided that the items are shipped to a common location designated by the group. Other suitable incentives may include, for example, a modification of the price of the items, incentive points that may be accumulated and exchanged for goods or services, premium shipping services, and/or any other suitable incentive.

If two or more of the individuals accept the system's invitation to form a delivery group, the system forms a delivery group that includes the individuals. The system may do this, for example, by associating the individuals with each other in a suitable database. The system may also store, in the database, the address of the delivery group's preferred common delivery location, and any backup delivery locations. Once the group is formed in the database, the system may direct any packages, which it identifies as being sent to any member of the delivery group, to the common location.

For example, if the system is hosted by a logistics provider, when a particular parcel is received by the logistics provider for delivery to any member of a particular delivery group, the system may automatically route or re-route the parcel to the delivery group's common delivery location. In various embodiments, the system may also automatically determine whether the logistics provider has received any other parcels that are to be delivered to other members of the delivery group. If so, the system may coordinate the aggregation of the parcels so that they are delivered together to the common delivery location.

In particular embodiments, the system may be adapted to coordinate a delay in the delivery of one or more particular parcels that is sufficient to allow the particular parcels to be aggregated with other parcels into a combined delivery to be made to the delivery group's common delivery location. For example, if the logistics provider receives a particular parcel that is addressed to a first member of a particular delivery group at a logistics hub, and the system also determines that that a second particular parcel that is addressed to a second member of the particular delivery group will be arriving at the logistics hub on the next day, the system may hold the first parcel at the logistics hub until the second parcel arrives at the logistics hub. The system may then facilitate delivery of the parcels together to the designated common delivery location.

The above approach may also be used to aggregate orders that are scheduled to be delivered to a single member of the group (or an individual that is not a member of a group). For example, the system may determine that a first parcel is scheduled to be delivered to a particular individual on a first day and a second parcel is scheduled to be delivered to a particular individual on the next day. After making this determination, the system may coordinate holding the first parcel for a day (e.g., at a logistics hub) and then delivering the first and second parcels together.

It should be understood, in light of this disclosure, that the system may be implemented in many different ways including as: 1) a browser plug-in; 2) a social network: 3) stand-alone software; 3) a mobile application; or 4) any other suitable software/hardware combination. In some embodiments, the system may be implemented on a logistics server.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, a smart mobile device, or another programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Group Delivery System 10 according to a particular embodiment of the present invention. As may be understood from this figure, the Group Delivery System 10 may include a Logistics Server 25, one or more Computer Networks 15, a Social Network Server 45 (e.g., any site that allows users to make connections and/or to publically or privately share data, pictures, videos, or information), one or more Third Party Servers 35 (e.g., a web hosting server, retailer's server, any other server that hosts websites), a Desktop Computer 14, and a Mobile Device 12 (e.g., a handheld device, a laptop, a smart phone, a tablet, or any other mobile computing device).

The one or more Computer Networks 15 facilitate communication between the Logistics Server 25, Social Network Server 45, Third Party Servers 35, Desktop Computer 14, and Mobile Device 12. These one or more Computer Networks 15 may include any of a variety of types of computer networks such as the Internet, a private intranet, a public switch telephone network (PSTN), WAN, LAN, or any other type of suitable network. In certain variations of the embodiment shown in FIG. 1, both the communication link between the Logistics Server 25, Third Party Servers 35, Social Network Server 45, Desktop Computer 14, and Mobile Device 12 are implemented via the Internet using Internet Protocol (IP). The communication link between the Logistics Server 25, Third Party Servers 35, and Social Network Server 45 may be, for example, implemented via a LAN or WAN.

It should be understood that the Servers 25, 35, and 45 do not necessarily need to be deployed over the network. For example, in various embodiments, it may be deployed locally on the user's computer, tablet, and/or mobile device.

FIG. 2 shows a block diagram of an exemplary embodiment of a computing device of FIG. 1 (e.g., the Logistics Server 25, the Third Party Servers 35, the Social Network Server 45; a Desktop Computer 14; or a Mobile Device 12). Although FIG. 2 may represent any of the devices above, for purposes of clarity and brevity, the Logistics Server 25 will serve as an example for the description of FIG. 2.

The Logistics Server 25 may include a Processor 60 that communicates with other elements within the Logistics Server 25 via a System Interface or Bus 61. The Logistics Server 25 may also include a Display Device/Input Device 64 for receiving and displaying data. This Display Device/Input Device 64 may be, for example, a keyboard, voice recognition, or pointing device that is used in combination with a monitor. The Logistics Server 25 may further include a Memory 66, which preferably includes both a Read Only Memory (ROM) 65 and a Random Access Memory (RAM) 67. The server's ROM 65 is used to store a Basic Input/Output System (BIOS) 26 that contains the basic routines that help to transfer information between elements within the Logistics Server 25.

Also located within the Logistics Server 25 may be a Network Interface 74 for interfacing and communicating with other elements of a computer network. It will be appreciated by one of ordinary skill in the art that one or more components of the Logistics Server 25 may be located geographically remote from other components of the Logistics Server 25. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD-ROM drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It is important to note that the computer-readable media described above could be replaced by any other type of computer-readable media known in the art. Such media includes, for example, magnetic cassettes, flash memory cards, digital video disks, and Bernoulli cartridges.

A number of program modules may be stored by the various storage devices and within the RAM 67. Such program modules include an Operating System 80, a Group Identification Module 100, Group Formation Module 102, and Group Delivery Module 104 (collectively a Group Identification, Formation, and Delivery Module 300. For simplicity and brevity, the Group Identification, Formation, and Delivery Module 300 is merely exemplary and may represent a number of program modules which control certain aspects of the operation of the Logistics Server 25 with the assistance of the Processor 60 and the Operating System 80. Exemplary embodiments of the Group Identification, Formation, and Delivery Module 300 are described in more detail below.

### Exemplary Group Identification, Formation, and Delivery Module

Certain embodiments of the Group Identification, Formation, and Delivery Module 300 are shown in FIG. 3. The Devices 12, 14 and the Servers 25, 35, 45 may alone, or in combination, perform the steps of FIG. 3. In various embodiments, all steps of FIG. 3 are performed by the exemplary Logistics Server 25. It should be understood by reference to this disclosure that these steps generally describe exemplary embodiments of the steps carried out by the present system, and that other exemplary embodiments may be created by adding other steps or by removing one or more of the steps shown in FIG. 3. It should also be understood that various systems, when executing the Group Identification, Formation, and Delivery Module 300, may omit particular functions or execute additional functions in performing the functions of the Group Identification, Formation, and Delivery Module 300.

Group Formation

Beginning at Step 302, the System 10 collects data associated with a plurality of users having one or more predetermined characteristics. In some embodiments, the users' one or more predefined characteristics include information associated with an account with a logistics company (e.g., an account associated with Logistics Server 25). For example, the system may be configured to collect data associated with users that are members of a logistics service (e.g., UPS MyChoice®). In this example, the data collected may include, for example, the geographic location of the user's home or workplace, the user's prior shipping or purchasing history, historical data for past deliveries that the user has received, the user's current shipping preferences, and other such information.

In various embodiments, the data is collected by multiple servers or web services. In this embodiment, the system is configured to collect and aggregate data from different sources about a user and associates the data with a single user account. In other embodiments, all data is collected by a single server or system of servers related to a single web service.

The system may be configured to collect data associated with any suitable entity. A “user” or “plurality of users” may be, for example, one or more individuals, businesses, group or groups of individuals, or any other entity that may make purchases online and/or receive deliveries associated with online purchases.

At Step 304, the system identifies, at least partially based on the collected data, at least one particular entity of the plurality of entities. In various embodiments, the system may identify any number of suitable entities based on the collected data. In some embodiments, the system is configured to identify two or more entities. In various embodiments, the system is configured to identify three or more entities, etc.

The system may be configured to identify the at least one particular entity based on any suitable predefined characteristic. In a particular embodiment, the system is configured to identify users (e.g., the at least one particular user) based on geographic location (e.g., two or more users live in close geographic vicinity and/or have parcels delivered in close geographic vicinity). In various embodiments, the system is configured to identify users based on what types of products the users order (e.g., two or more users frequently order tennis balls). In further embodiments, the system is configured to identify users based on any other suitable characteristic, such as going to the same school (e.g., university), working for the same location, and/or having similar regular parcel delivery schedules (e.g., they typically receive parcels on at least one common day of the week).

In still further embodiments, the system is configured to identify the users based on a combination of characteristics. For example, the system may be configured to identify the users based on information that the users all live in the same neighborhood and order the similar products (e.g., two users live in the same neighborhood, on the same block, and both order tennis balls every month).

At Step 306, the system suggests to a particular user, at least partially based on the collected data, to form a group that allows purchases from each group member to be delivered to a designated location. The system may be configured to suggest forming the group in any suitable way. In various embodiments, the system is configured to make a suggestion to a particular user by sending the user a message (e.g., an email, SMS, message on a social network, or any other suitable message), by displaying a notification (e.g., a notification on a social network and/or a pop-up notification), and/or by displaying a webpage.

In particular embodiments, the suggestion to form the group (e.g., the message, notification, and/or webpage) includes an incentive for the users. The incentive may be any suitable incentive. In various embodiments, the incentive is an offer for a discount on shipping. In a particular embodiment, the incentive is an offer for incentive points (e.g., points the user or users may exchange for an award).

For example, the system may be configured to collect data associated with users' respective geographic locations. In this example, if the system determines that there is more than one user within close geographic vicinity to each other, the system sends a particular user an offer for a predetermined incentive if they form the suggested group for the delivery of parcels.

At Step 308, the system receives an indication from the particular user of the user's desire to form the delivery group. The notification may be in any suitable form. In various embodiments, the notification is a message on a social network. In some embodiments, the notification is an email, SMS message, and/or a response to the suggestion made by the system in Step 306.

At Step 310, the system facilitates formation of the group. In various embodiments, the system is configured to facilitate formation of the group by enabling the particular user and other users to form the group. The system may be configured to enable the users to form the group in any suitable way. In various embodiments, the system is configured to form (and/or enable formation of) the group by creating a formal association between the accounts of the group members. According to a particular embodiment, the system is configured to enable the user to form the group by creating a social network group. In some embodiments, creating this association includes giving group members limited access to each other's account information.

Designation of a Group Delivery Location

Continuing with Step 312, the system enables one or more users from the group (or another individual) to designate a delivery location for one or more purchases made by the group members. The designated delivery location may be any suitable location. In some embodiments, the designated delivery location is a residence associated with a group member. In one or more embodiments the designated delivery location is an attended delivery/pickup location (e.g., an attended location that accepts locations for one or more users). In further embodiments, the designated delivery location is a location that includes a user-accessible locker (e.g., a locker or other locking storage system for storing one or more parcels). In various embodiments, the designated delivery location is an office building associated with a particular group member (e.g., the group member's workplace). In particular embodiments, the designated delivery location is a location central to all group members such as a subdivision office building, a neighborhood meeting place, a school, a local coffee shop, or any other suitable delivery location.

Once a delivery location is designated for the delivery group, at Step 314, the system facilitates delivery of an item to the designated delivery location. In some embodiments, the system is configured to receive notification of a group member's online purchase (e.g., from the Third Party Servers 35) and substantially automatically (e.g., automatically) assigns the online purchase for delivery to the designated delivery location. In other embodiments, the system may be configured to receive a notice that a group member is scheduled to receive a parcel in the future, and—in response to receiving the notice—the system is configured to reroute (or facilitate rerouting of) the incoming parcel to the designated delivery location.

In particular embodiments, the system is configured to facilitate holding one or more parcels until more parcels are received (e.g., the system is configured to facilitate holding one or more parcels for a first group member until one or more parcels for a second group member arrive). In this (and other) embodiments, the system is then configured facilitate delivery of the parcels (e.g., the one or more parcels that have been held and the other received parcels).

In one or more embodiments, the system is configured to hold one or more parcels for a predetermined amount of time. In various embodiments, the predetermined amount of time may be different depending on the type of the one or more parcels being held (e.g., a shorter time predetermined amount of time for one or more parcels containing perishable items than a predetermined amount of time for one or more parcels containing non-perishable items). The predetermined amount of time may any suitable amount of time for holding one or more parcels, including: 1) six hours; 2) one day; 3) two days; 4) one week; and/or 5) any other suitable predetermined time.

In various embodiments, the system is configured to aggregate the orders of different users of a group for a single delivery to the designated delivery location. In this embodiment, the orders may be from the same or different retailers. The system may further be configured to offer group price modifications on the items ordered, modified shipping costs, or special shipping options to group members (alternate delivery locations, aggregating packages, package hold, etc.).

### Example of the Group Identification, Formation, and Delivery Module Shown in FIG. 3

As a particular example, assume that User A and User B are: (1) formally associated with each other on a social network (e.g., they are “friends” on Facebook®); (2) each members of a particular logistics service, such as UPS' MyChoice® service; and (3) live within a mile of each other. In a particular embodiment, the system (which may, for example, be implemented by a logistics provider or online retailer) collects purchasing and geographic data for all members of the logistics service, including User A and User B. By analyzing User A and User B's respective purchasing, geographic, and social network data, the system determines that User A and User B both typically receive parcels every Tuesday, are formally associated with each other on a social network, and live within a few blocks of each other. Based on this information, the system determines that it would be advantageous for User A and User B to form a delivery group.

The system then facilitates sending a message to User A and User B asking if they would like to form a delivery group, which would involve having any incoming parcels that are scheduled to be delivered by one or more particular logistics providers (or that are ordered from one or more particular online retailers) delivered to a common location (e.g., User A's house or residence). The company may entice the users to accept the offer in any suitable way—for example, by offering an incentive (e.g., bonus points, an adjustment in price, etc.) for each of the one or more parcels that are delivered to any member of the group.

If User A and User B accept the terms of the offer, the system facilitates the combined delivery of any parcels that are scheduled to be delivered to any member of the group to User A's house, which reduces the delivery last mile cost by directly delivering User A and User B's parcels to a single location. This is especially efficient on Tuesdays, when both User A and User B typically receive parcels.

### Exemplary Group Delivery Package Aggregation

FIGS. 4A and 4B are exemplary group delivery package aggregation diagrams. The elements of FIGS. 4A and 4B visually depict how the Group Delivery Modules may function in one embodiment. Solid lines denote parcel delivery by a logistics company and dashed lines denote delivery by a user. For this example, there are three Users: User 1, User 2, and User 3 (collectively “Users”). The Users have three common characteristics. First, Users 1, 2, and 3 live in the same neighborhood. Second, the Users are connected on a social network (e.g., the users are Facebook® “friends”). Finally, the Users all have parcels scheduled for delivery within two days. The delivery details are as follows:
User 1: Parcel 411 delivery from Retailer 401 on Day 1 to User 1's Residence 421;
User 2: Parcel 412 delivery from Retailer 402 on Day 2 to User 2's Residence 422; and
User 3: Parcel 413 delivery from Retailer 403 on Day 2 to User 3's Office 440.

FIG. 4A shows a typical delivery pattern, from the Retailers 401, 402, and 403 to a Distribution Facility 430 and then to the Users' Residences 421, 422 and Office 440. FIG. 4B depicts an example of how the Group Delivery Modules may change the delivery pattern.

To begin, at FIG. 4B, the system collects data about the Users (e.g., Step 302 in FIG. 3). The system then determines that the Users have certain predetermined characteristics including: (1) the Users live in the same geographic area; (2) the Users are connected on a social network and, therefore, likely know each other; and (3) each User is scheduled to receive one or more parcels within the next two days. Based on the above information, the system suggests that the users form a delivery group (e.g., Step 306 in FIG. 3). The system may also suggest that the group members designate a delivery location for all packages. The system additionally enables the Users to join an incentive program if they form the group, accept a delivery date within two days (rather than one), and designate a delivery location for the parcels.

The Users designate User 3's Office 440 as a common delivery location for the group. User 3's office has a secretary that signs for all packages, which makes accepting deliveries here very convenient. User 3 then offers to drive the Combined Parcel 450 to User 3's Residence 423, where User 1 and User 2 can pick up their parcels.

Continuing with FIG. 4B, the system facilitates aggregation of the parcels at a designated point, such as a Distribution Facility 430. The Parcels 411, 412, and 413 are combined into a single Combined Parcel 450. The Combined Parcel 450 is then delivered to User 3's Office 440 where User 3's secretary signs for the packages. At the end of the workday, User 3 takes the Combined Parcel 450 to User 3's Residence 423 within the neighborhood that User 3 shares with User 1 and User 2. Users 1 and 2 then pick up Parcel 411 and Parcel 412, respectively, at their leisure and bring the parcels to their residences, 421 and 422.

### Alternative Embodiments

Alternative embodiments of the system may comprise features that are, in some respects, similar to the various components described above. Selected distinguishing features of these alternative embodiments are discussed below.

### The System May Make User Introductions

In some embodiments, the system may be configured to make an introduction among a subset of users from the plurality of users to form a group for delivery purposes. The introduced members may then informally discuss the potential of aggregating the delivery of packages to a central location.

### A Delivery Location May be Designated in any Suitable Way

In various embodiments, various methods may be used to designate a designated delivery location. In several embodiments, the group may choose a group leader who may designate the designated delivery location. In further embodiments, the system may suggest a designated delivery location. In several embodiments, the designated delivery location may be chosen with each delivery. In other embodiments, the designated location may be changed based on the dynamics of the group. According to particular embodiments, delivery to the designated delivery location may be optional.

In some embodiments, the designated delivery location is populated from or to a user's online address book. In this embodiment, the user chooses the group delivery location from the address book when choosing shipping options for the purchase. Moreover, users in the group may update the designated delivery location to their contact information to assist in obtaining driving directions to the delivery location.

### The System May Suggest Delivery Groups Based on Delivery Patterns

In various embodiments, the system may be configured to collect data associated with a plurality of entities (e.g., such as individuals or businesses) that includes data relating to delivery patterns for parcels delivered to each of the plurality of entities (e.g., to an address associated with each entity such as a residence or business address). In particular embodiments, the system may utilize delivery pattern information to suggest to particular entities with substantially similar (e.g., similar) delivery patterns to form a group for delivery purposes. Substantially similar delivery patterns may include, for example: (1) typically having parcels delivered on similar days of the week (e.g., Monday, Tuesday, etc.); 3(2) typically having parcels delivered on similar parts of the week (e.g., early in the week, midweek, end of the week, during the weekend, etc.); (3) typically having parcels delivered during particular times of the year (e.g., during and leading up to holidays such as Christmas); (4) typically having parcels delivered based on particular times of the month (e.g., beginning, middle or end); and (5) any other suitable pattern of delivery that is based, for example, on timing of deliveries being sufficiently close such that it may benefit a common carrier to group or otherwise combine the deliveries in order to limit a number of delivery trips required. For example, if three individuals that live in a particular neighborhood typically have parcels delivered on a particular day of the week (e.g., on a Tuesday), the system may suggest that those individuals form a group for delivery purposes. In such embodiments, a common carrier coordinating deliveries to the three individuals may only have to make a delivery to one location (e.g., such as one of the residences of the three individuals) on the particular day of the week. The three individuals may then go to the individual's residence to which the parcels were delivered to retrieve their parcels.

As discussed above, there are many different ways the system may be implemented. For example, if implemented through a browser add-on, a user may assign shipping preferences by using a number or password associated with an account with a logistics company.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for forming delivery groups comprising:
at least one processor, wherein the computer system is configured for:
(A) collecting data associated with a plurality of entities, wherein the collected data comprises historical data associated with one or more purchases made by the plurality of entities;
(B) at least partially based on the collected data, suggesting, to at least one particular entity of the plurality of entities, forming a delivery group;
(C) receiving, from the at least one particular entity, a request to form the delivery group;
(D) at least partially in response to receiving the request, facilitating formation of the delivery group, wherein:
the delivery group comprises one or more members; and
the one or more members of the delivery group comprise at least one entity of the plurality of entities;
(E) enabling at least one delivery group member to designate a delivery location, wherein the delivery location comprises a location where all delivery group members can have parcels delivered; and
(F) facilitating delivery of a parcel to the designated delivery location.

2. The computer system of claim 1, wherein the collected data comprises historical delivery data associated with at least one parcel delivered to a location associated with at least one particular entity of the plurality of entities.

3. The computer system of claim 2, wherein the system is further configured for, at least partially based on the historical data, identifying at least one particular entity of the plurality of entities.

4. The computer system of claim 3, wherein:
(A) the at least one particular entity of the plurality of entities comprises a first particular entity and a second particular entity;
(B) identifying at least one particular entity of the plurality of entities at least partially based on the historical data comprises identifying the first particular entity and the second particular entity; and
(C) suggesting to at least one particular entity of the plurality of entities to form the delivery group comprises suggesting to the first particular entity and the second particular entity to form the delivery group.

5. The computer system of claim 4, wherein the historical data associated with each of the first and second particular entities is data selected from the group consisting of:
(A) geographic information;
(B) purchase information; and
(C) social network information.

6. The computer system of claim 4, wherein:
(A) the historical data associated with each of the first and second particular entities comprises geographic information identifying a location where each of the respective entities has had a parcel delivered; and
(B) identifying the first particular entity and the second particular entity comprises determining, at least partially based on the geographic information, that the identified location where the first entity has had the first parcel delivered and the identified location where the second entity has had the second parcel delivered are geographically nearby.

7. The computer system of claim 6, wherein the identified location where the first entity has had the first parcel delivered and the identified location where the second entity has had the second parcel delivered are located in a particular neighborhood.

8. The computer system of claim 6, wherein the identified location where the first entity has had the first parcel delivered and the identified location where the second entity has had the second parcel delivered are located in a particular office building.

9. The computer system of claim 4, wherein:
(A) the historical data associated with the first and second particular entities comprises information associated with a particular item each of the first and second particular entities has purchased; and
(B) identifying the first particular entity and the second particular entity comprises determining, at least partially based on the information associated with the particular item, that the particular item the first entity purchased and the particular item the second entity purchased are substantially similar.

10. The computer system of claim 9, wherein the particular item the first entity purchased and the particular item the second entity purchased are a particular item.

11. The computer system of claim 9, wherein the particular item the second entity purchased is an accessory of the particular item the first entity purchased.

12. The computer system of claim 1, wherein the collected data comprises data collected from one or more servers selected from the group consisting of:
(A) one or more logistics servers;
(B) one or more social network servers; and
(C) one or more retailer servers.

13. The computer system of claim 1, wherein suggesting, to at least one particular entity of the plurality of entities, forming the delivery group comprises providing an incentive to the at least one particular entity of the plurality of entities for forming the delivery group.

14. The computer system of claim 13, wherein providing the incentive comprises offering the at least one particular entity a discount on shipping.

15. The computer system of claim 13, wherein providing the incentive comprises offering the at least one particular entity incentive points.

16. The computer system of claim 13, wherein providing the incentive comprises offering the at least one particular entity a discount on particular purchased items.

17. The computer system of claim 13, wherein suggesting, to at least one particular entity of the plurality of entities, forming the delivery group comprises transmitting a message to a client device associated with the at least one particular entity, wherein the message comprises the incentive.

18. The computer system of claim 1, wherein the computer system is further configured for:
(A) determining whether a logistics provider has received a first particular parcel associated with a first particular group member;
(B) at least partially in response to determining that the logistics provider has received the first particular parcel associated with the first particular group member, facilitating the logistics provider holding the first particular parcel until the system receives an indication that the logistics provider has received at least a second particular parcel associated with a second particular group member; and
(C) facilitating delivery of the first particular parcel and the second particular parcel to the designated delivery location.

19. The computer system of claim 18, wherein facilitating the logistics provider holding the first particular parcel until the system receives an indication that the logistics provider has received at least the second particular parcel comprises holding the first particular parcel for a predetermined time limit.

20. The computer system of claim 19, wherein the predetermined time limit is two days.

21. A computer system for forming delivery groups comprising:
at least one processor, wherein the computer system is configured for:
(A) collecting first user historical data associated with a first user, wherein the first user historical data comprises information associated with one or more purchases made by the first user;
(B) collecting second user historical data associated with a second user, wherein the second user historical data comprises information associated with one or more purchases made by the second user;
(C) at least partially based on the collected first user historical data and the collected second user historical data, determining that the first user and the second user may form a delivery group;
(D) suggesting, to the first and second users, forming a delivery group;
(E) receiving a request, from the first and second users, to form the delivery group;
(F) facilitating formation of the delivery group, wherein:
the delivery group comprises one or more members; and
the one or more members of the delivery group comprise the first user and the second user;
(G) enabling at least one delivery group member to designate a delivery location, wherein the delivery location comprises a location where all delivery group members can have parcels delivered; and
(H) facilitating delivery of a parcel to the designated delivery location.

22. The computer system of claim 21, wherein:
(A) the first user historical data comprises a first location where the first user had at least one parcel delivered;
(B) the second user historical data comprises a second location where the second user had at least one parcel delivered; and
(C) determining that the first user and the second user may form the delivery group comprises determining that the first location and the second location are geographically nearby.

23. The computer system of claim 22, wherein the first location and the second location are a particular location.

24. The computer system of claim 22, wherein the first location and the second location are a particular location within a particular neighborhood.

25. The computer system of claim 22, wherein the first location and the second location are a within a particular office building.

26. The computer system of claim 22, wherein suggesting, to the first and second users, forming the delivery group comprises providing an incentive to the first and second users for forming the delivery group.

27. The computer system of claim 26, wherein providing the incentive comprises offering a discount on shipping.

28. The computer system of claim 26, wherein providing the incentive comprises offering incentive points.

29. The computer system of claim 26, wherein providing the incentive comprises offering a discount on particular purchased items.

30. A computer system for forming delivery groups comprising:
at least one processor, wherein the computer system is configured for:
(A) collecting first user historical data associated with a first user, wherein the first user historical data comprises a first location where one or more parcels associated with at least one purchase made by the first user have been delivered;
(B) collecting second user historical data associated with a second user, wherein the second user historical data comprises a second location where one or more parcels associated with at least one purchase made by the second user have been delivered;
(C) at least partially based on the collected first user historical data and the collected second user historical data, determining that the first location and the second location are geographically nearby;
(D) at least partially in response to determining that the first location and the second location are geographically nearby, suggesting, to the first and second users, forming a delivery group, wherein suggesting forming the delivery group comprises transmitting a message to the first and second users;
(E) facilitating formation of the delivery group, wherein the delivery group comprises the first and second users;
(F) enabling the first user to designate a delivery location, wherein the delivery location comprises a location where all delivery group members can have parcels delivered; and
(G) facilitating delivery of a parcel to the designated delivery location.

31. A method for forming a delivery group comprising:
(A) receiving, by at least one processor, an indication that at least one user of a plurality of users desires to form a group for the delivery of one or more items;
(B) at least partially in response to receiving the indication that the user of the plurality of users desires to form the group, determining, by at least one processor, a designated delivery/pickup location for the group, the designated delivery/pickup location is a default delivery and pickup location for the group;
(C) suggesting the designated delivery/pickup location to the at least one user; and
(D) facilitating, by at least one processor, the delivery of at least one parcel to the designated delivery/pickup location.

32. The method of claim 31, wherein:
(A) the method further comprises:
i) receiving a location for each of the plurality of users;
ii) receiving, by at least one processor, an indication of which of the plurality of users are members of the group;
(B) the members of the group comprise a first user and a second user; and
i) determining a half-way location about equidistant from the location of the first user and the location of the second user;
ii) receiving route information associated with the half-way location, the route information comprising one or more routes a logistics provider uses to deliver one or more parcels near the half-way location;
(C) determining the designated delivery/pickup location is based at least in part on:
i) the location of the first user;
ii) the location of the second user; and
iii) the route information associated with the half-way location.

33. The method of claim 32, wherein the designated delivery/pickup location is a retailer:
(A) about equidistant from the location of the first user and the location of the second user; and
(B) along at least one route the logistics provider users to deliver one or more parcels.

34. The method of claim 31, wherein determining the designated delivery/pickup location comprises:
(A) receiving a location for each user of the plurality of users;
(B) receiving route information associated with each user of the plurality of users, the route information comprising one or more planned routes a logistics company uses to delivery one or more parcels to each user of the plurality of users; and
(C) determining the designated delivery/pickup location based at least in part on:
i) the received route information; and
ii) the received location for each user of the plurality of users.

35. The method of claim 34, wherein the location for each user of the plurality of users comprises an address for each user of the plurality of users.

36. The method of claim 34, wherein the location for each user of the plurality of users comprises a virtual address for each user of the plurality of users.

37. The method of claim 34, wherein the designated delivery/pickup location is a location selected from the group consisting of:
(A) a virtual address for a particular user of the plurality of users;
(B) an address for a particular user of the plurality of users;
(C) an attended delivery/pickup location; and
(D) a retailer.

38. The method of claim 34, wherein:
(A) the method further comprises receiving, by at least one processor, an indication of which of the plurality of users are members of the group;
(B) the members of the group comprise a first user and a second user.

39. The method of claim 38, wherein determining the designated delivery/pickup location based at least in part on:
(A) the received route information associated with each of the first user and the second user; and
(B) the received location for each of the first user and the second user.

40. The method of claim 39, wherein the designated delivery/pickup location comprises a location about half way between the received location of the first user and the received location of the second user.

41. The method of claim 40, wherein the designated delivery/pickup location comprises a retailer.

42. The method of claim 39, wherein the designated delivery/pickup location comprises a location:
(A) about half way between the received location of the first user and the received location of the second user; and
(B) associated with the received route information associated with each of the first user and the second user.

43. A method for forming a delivery group comprising:
(A) receiving, by at least one processor, delivery information associated with each of a plurality of users, the delivery information comprising geographic information associated with at least one delivery for each of the plurality of users;
(B) based at least in part on the delivery information associated with each of the plurality of users, suggesting, by at least one processor, forming a delivery group to a first user of the plurality of users and a second user of the plurality of users;
(C) suggesting to at least the first user, by at least one processor, a designated delivery/pickup location for the delivery group, the designated delivery/pickup location a default location for the delivery and pickup of one or more parcels associated with each of the first and second users; and
(D) facilitating, by at least one processor, a delivery of at least one parcel to the designated delivery/pickup location.

44. The method of claim 43, wherein suggesting forming the delivery group to the first user of the plurality of users and the second user of the plurality of users comprises making an introduction of the first user and the second user.

45. The method of claim 44, wherein the introduction of the first user and second user is associated with a social network.

46. The method of claim 45, wherein the social network is a selected from the group consisting of:
(A) a private social network;
(B) a public social network; and
(C) a business social network.
